(19) United States
(12) Patent Application Publication
(10) Pub. No.: US 2024/0181717 A1
(43) Pub. Date: Jun. 6, 2024

(54) Method of Producing Three-Dimensional Object, Control System and Additive Manufacturing Device

(71) Applicant: ABB Schweiz AG, Baden (CH)

(72) Inventors: Thorsten Strassel, Mülligen (CH); Chau Hon Ho, Lörrach (DE); Elisabet Capon, Zurich (CH); Stefano Maranò, Zurich (CH); Ioannis Lymperopoulos, Dietikon (DE); Robin Verschueren, Zurich (CH); Gabriel Schuler, Arth (CH)

(21) Appl. No.: 18/553,236

(22) PCT Filed: Apr. 6, 2021
(86) PCT No.: PCT/EP2021/058934

§ 371 Date: Sep. 29, 2023

(51) Int. Cl. B29C 64/40; B29C 64/393; B33Y 30/00; B33Y 40/20; B33Y 50/02

(52) U.S. Cl. CPC B29C 64/40; B29C 64/393; B33Y 30/00; B33Y 40/20; B33Y 50/02

(57) ABSTRACT

A method of producing a three-dimensional object, the method including providing an object model of the three-dimensional object; providing a candidate support structure model of one or more support structures for the three-dimensional object based on the object model; selecting a removal strategy among a plurality of candidate removal strategies for removal of the one or more support structures from the three-dimensional object based on the object model; modifying the candidate support structure model based on the selected removal strategy to provide a modified support structure model; forming the three-dimensional object based on the object model, and the one or more support structures supporting the three-dimensional object based on the modified support structure model, by means of additive manufacturing; and removing the one or more support structures from the three-dimensional object based on the selected removal strategy.

### TECHNICAL FIELD

The present disclosure generally relates to additive manufacturing. In particular, a method of producing a three-dimensional object by means of additive manufacturing, a control system for an additive manufacturing device, and an additive manufacturing device for producing a three-dimensional object, are provided.

### BACKGROUND

Additive manufacturing (AM), also known as 3D printing, is a manufacturing method which is implemented in a wide range of industries. When producing a three-dimensional object by means of additive manufacturing, support structures are commonly used to support the three-dimensional object to maintain integrity during the build phase and for heat transfer. The support structures are printed in the same way as the three-dimensional object.

Although the printing steps as such are highly automated, there are still many manual and elaborative processes involved in the additive manufacturing process from raw material to finished part. For example, the support structures can be designed to improve their functionality during the print phase and to reduce material consumption, but the prior art does not provide any optimization of removal of the support structures. Most prior art solutions require complicated post-processing steps after the three-dimensional object has been produced. Such processing steps may comprise removal of the support structures and smoothing of the surfaces of the three-dimensional object.

The support structures are often relatively rigid and are typically removed manually by using mechanical tools, such as knives, pliers or handheld rotary tools. The subsequent smoothing may for example comprise sanding or polishing. These post processing steps are time-consuming and have to be performed carefully considering the risk of damaging the costly three-dimensional object. Such post processing steps also not scalable. In some implementations, the costs derivable to post processing can amount to roughly one third of the production cost.

WO 2019125970 A1 discloses an additive manufacturing system using a trained artificial intelligence module as part of a closed-loop control structure for adjusting the initial set of build parameters in-process to improve part quality. The closed-loop control structure includes a slow control loop taking into account in-process build layer images, and may include fast control loop taking into account melt pool monitoring data.

### SUMMARY

One object of the present disclosure is to provide an improved method of producing a three-dimensional object by means of additive manufacturing.

A further object of the present disclosure is to provide a method of producing a three-dimensional object by means of additive manufacturing, which method enables an improved removal of support structures from the three-dimensional object.

A still further object of the present disclosure is to provide a method of producing a three-dimensional object by means of additive manufacturing, which method enables an improved quality of the three-dimensional object.

A still further object of the present disclosure is to provide a method of producing a three-dimensional object by means of additive manufacturing, which method is cost-efficient.

A still further object of the present disclosure is to provide a method of producing a three-dimensional object by means of additive manufacturing, which method solves several or all of the foregoing objects in combination.

A still further object of the present disclosure is to provide a control system for an additive manufacturing device, which control system solves one, several or all of the foregoing objects.

A still further object of the present disclosure is to provide an additive manufacturing device comprising a control system, which additive manufacturing device solves one, several or all of the foregoing objects.

According to a first aspect, there is provided a method of producing a three-dimensional object, the method comprising providing an object model of the three-dimensional object; providing a candidate support structure model of one or more support structures for the three-dimensional object based on the object model; selecting a removal strategy among a plurality of candidate removal strategies for removal of the one or more support structures from the three-dimensional object based on the object model; modifying the candidate support structure model based on the selected removal strategy to provide a modified support structure model; forming the three-dimensional object based on the object model, and the one or more support structures supporting the three-dimensional object based on the modified support structure model, by means of additive manufacturing; and removing the one or more support structures from the three-dimensional object based on the selected removal strategy.

The method enables improvement of the design of the support structures based on a selected removal strategy, such as a selected removal technology. By modifying the candidate support structure model based on the selected removal strategy to provide the modified support structure model, the removal of the support structure can be improved and/or the support structures can be reduced in size. Examples of improvements of the removal include a faster removal time and/or an improved surface quality.

The object model may contain data defining the shape, dimension, texture and/or material of the three-dimensional object. The candidate support structure model and the modified support structure model may contain data defining the shape, dimension, texture and/or material of the one or more support structures. Each of the object model, the candidate support structure model and the modified support structure model may be a CAD (computer-aided design) model. The candidate support structure model may be provided based on one or more parameters of the object model.

The selection of the removal strategy may be made automatically or manually. In any case, the selection of the removal strategy may be made based on the object model. The selection of the removal strategy among the plurality of candidate removal strategies for removal of the one or more support structures from the three-dimensional object may additionally be based on the candidate support structure model. In case the removal strategy is selected purely based on the candidate support structure model, the removal strategy is indirectly selected based on the object model since the candidate support structure model is provided based on the object model.

The method thus comprises selecting the removal strategy directly or indirectly based on the object model.

The modification of the candidate support structure model to provide the modified support structure model may comprise modifying a shape of one or more of the at least one support structures. According to one example, the modification may comprise modifying one or more interconnections of the support structures to the three-dimensional object.

The method may further comprise adjusting the selected removal strategy. The adjustment may be made online and/or offline.

The three-dimensional object and the one or more support structures may be formed by means of a wide range of additive manufacturing technologies. Examples include selective laser sintering (SLS), selective laser melting (SLS), fused deposition modeling (FDM), stereolithography apparatus (SLA) and other material jetting technologies. The forming may comprise repeatedly forming a solidified layer by irradiating a predetermined portion of a powder layer with a light beam, thereby allowing a sintering of the powder in the predetermined portion or a melting and subsequent solidification thereof; and forming another solidified layer by newly forming a powder layer on the resulting solidified layer, followed by the irradiation of a predetermined portion of the metal powder layer with the light beam. The powder may comprise metal, ceramics and/or plastics.

Support structures can be removed from the three-dimensional object with various different removal technologies, for example by subtractive removal. The removal of the one or more support structures from the three-dimensional object based on the selected removal strategy may comprise removing the one or more support structures from the three-dimensional object by means of the selected removal strategy, or by means of a removal strategy that is adjusted based on the selected removal strategy.

The support structures are sacrificial. That is, the support structures are not included in the targeted design of the three-dimensional object.

The method may further comprise estimating one or more process values associated with the selected removal strategy for the candidate support structure model; and modifying the candidate support structure model based on the one or more process values to provide the modified support structure model. The process values may be values of various process parameters associated with the selected removal strategy.

The method may further comprise performing optimization of the candidate support structure model to satisfy an objective function associated with the one or more process values to output an optimized support structure model; and using the optimized support structure model as the modified support structure model.

The selection of the removal strategy and/or the modification of the candidate support structure model may be made by means of machine learning, such as reinforcement learning. The machine learning may be performed by means of a machine learning system according to the present disclosure. Furthermore, the selected removal strategy may be adjusted online and/or offline by means of machine learning.

The forming of the three-dimensional object and the removal of the one or more support structures may be performed by means of an additive manufacturing device. In this case, the method may further comprise providing a digital twin of the additive manufacturing device; and selecting the removal strategy and/or modifying the candidate support structure model by using the digital twin. The digital twin is a virtual model of the additive manufacturing device. The digital twin may comprise one or more virtual components each corresponding to a component of the additive manufacturing device. The digital twin may be configured to render at least one virtual output parameter by simulating the selected removal strategy in the digital twin.

The candidate removal strategies may be associated with different removal trajectories. Thus, two different candidate removal strategies may use the same removal technology but may be executed with different removal trajectories. As used herein, a removal trajectory comprises a geometric path and optionally a speed and acceleration profile along the path. The removal trajectory be executed by an end effector, for example of a robotic manipulator or a CNC (computer numerical control) machine.

The method may for example comprise selecting a removal technology and a removal trajectory among a plurality of candidate removal strategies having different removal trajectories. The method may further comprise adjusting the selected removal strategy by adjusting one or more process parameters, for example based on the modified support structure model.

The candidate removal strategies may be associated with different tools. Thus, two different candidate removal strategies may use the same removal trajectory but may be executed with different tools. Removal strategies executed with different tools are herein referred to as different removal technologies. The method may further comprise adjusting the selected removal strategy by adjusting one or more removal trajectories and/or by adjusting one or more process parameters, for example based on the modified support structure model.

The tools may comprise a laser tool, a jetting tool, a machining tool and/or a vibrating tool. The jetting tool may for example be an abrasive liquid jetting tool, such as an abrasive water injection jetting tool or an abrasive water suspension jet. The machining tool may for example be a milling tool. The vibrating tool may for example be a gripper comprising a vibration motor for vibrating the gripper. By means of the gripper, the three-dimensional object can be gripped. The laser tool may be a laser vaporization tool.

Interconnections may be provided between the three-dimensional object and the one or more support structures. The interconnections may have a thickness of less than 2 mm, such as less than 1 mm. In this way, the interconnections can be cut by means of laser vaporization cutting instead of laser fusion cutting. Alternatively, or in addition, the interconnections may be tapered towards the three-dimensional object.

Each support structure may comprise a body. The body may be wider than the associated interconnection.

The candidate removal strategies may include one or more vibration removal strategies comprising introducing vibrations to one or more of the support structures to excite an eigenfrequency of the one or more support structures such that one or more interconnections between the three-dimensional object and each of the one or more support structures brake. The vibrations may be induced in the three-dimensional object and/or in a baseplate to be introduced in the one or more support structures.

According to a second aspect, there is provided a control system for an additive manufacturing device, the control system comprising at least one data processing device and at least one memory having at least one computer program stored thereon, the at least one computer program comprising program code which, when executed by the at least one data processing device, causes the at least one data processing device to perform the steps of providing an object model of a three-dimensional object; providing a candidate support structure model of one or more support structures for the three-dimensional object based on the object model; providing a selection of a removal strategy among a plurality of candidate removal strategies for removal of the one or more support structures from the three-dimensional object based on the object model; modifying the candidate support structure model based on the selected removal strategy to provide a modified support structure model; commanding forming of the three-dimensional object based on the object model, and the one or more support structures supporting the three-dimensional object based on the modified support structure model, by means of additive manufacturing; and commanding removal of the one or more support structures from the three-dimensional object based on the selected removal strategy.

The at least one computer program comprising program code which, when executed by the at least one data processing device, causes the at least one data processing device to perform, and/or command performance of, various steps described herein. For example, the at least one computer program may comprise program code which, when executed by the at least one data processing device, causes the at least one data processing device to perform the step of selecting the removal strategy among the plurality of candidate removal strategies.

The commanding of removal of the one or more support structures may comprise controlling a removal machine, such as a robotic manipulator or a CNC machine.

The at least one computer program may comprise program code which, when executed by the at least one data processing device, causes the at least one data processing device to perform the steps of estimating one or more process values associated with the selected removal strategy for the candidate support structure model; and modifying the candidate support structure model based on the one or more process values to provide the modified support structure model.

The at least one computer program may comprise program code which, when executed by the at least one data processing device, causes the at least one data processing device to perform the steps of performing optimization of the candidate support structure model to satisfy an objective function associated with the one or more process values to output an optimized support structure model; and using the optimized support structure model as the modified support structure model.

The selection of the removal strategy and/or the modification of the candidate support structure model may be made by means of machine learning, such as reinforced learning. To this end, a machine learning system may be implemented in the control system. The machine learning system may comprise a machine learning agent. The machine learning agent may be configured to autonomously select a removal technology, to generate removal trajectories and to generate process values for the selected removal strategy. The machine learning agent may be trained both offline, before the removal process, and/or online, during the removal process. In each case, the training may be performed by using the digital twin. The machine learning system may further comprise a database where historical process values from previous printing processes and/or removal processes are stored.

The forming of the three-dimensional object and the removal of the one or more support structures may be performed by means of an additive manufacturing device. In this case, the at least one computer program may comprise program code which, when executed by the at least one data processing device, causes the at least one data processing device to perform the steps of providing a digital twin of the additive manufacturing device; and selecting the removal strategy and/or modifying the candidate support structure model based on the digital twin.

The candidate removal strategies may be associated with different removal trajectories. Alternatively, or in addition, the candidate removal strategies may be associated with different tools.

The tools may comprise a laser tool, a jetting tool, a machining tool and/or a vibrating tool. The laser tool may be a laser vaporization tool.

The candidate removal strategies may include a vibration removal strategy comprising introducing vibrations to one or more of the support structures to excite an eigenfrequency of the one or more support structures such that one or more interconnections between the three-dimensional object and each of the one or more support structures brake.

According to a third aspect, there is provided an additive manufacturing device for producing a three-dimensional object. The additive manufacturing device comprises a control system according to the present disclosure. The additive manufacturing device of the third aspect may be of any type as mentioned for the first aspect, and vice versa.

The additive manufacturing device may comprise a printing machine and a removal machine. Each of the printing machine and the removal machine may for example comprise a robotic manipulator or a CNC machine. Alternatively, each of the printing machine and the removal machine may be carried by a common robotic manipulator or by a common CNC machine. The additive manufacturing device may further comprise a clamp for holding the three-dimensional object during removal of the support structures.

According to a fourth aspect, there is provided a method of removing one or more support structures from a three-dimensional object produced by additive manufacturing, the method comprising forming the three-dimensional object and the one or more support structure by means of additive manufacturing; subjecting the three-dimensional object to vibrations exciting an eigenfrequency of each of the support structures to break the support structures from the three-dimensional object. The method may further comprise forming a weight on the support structure by means of additive manufacturing. In case a plurality of support structures are formed, at least one support structure may have a first eigenfrequency and at least one of the support structures may have a second eigenfrequency, different from the first eigenfrequency.

### BRIEF DESCRIPTION OF THE DRAWINGS

Further details, advantages and aspects of the present disclosure will become apparent from the following description taken in conjunction with the drawings, wherein:

FIG. 1: schematically represents a side view of an additive manufacturing device;

FIG. 2a: schematically represents a side view of one example of a support structure removal strategy using a laser tool;

FIG. 2b: schematically represents a side view of a further example of a support structure removal strategy using the laser tool;

FIG. 2c: schematically represents a perspective view of a further example of a support structure;

FIG. 2d: schematically represents a perspective view of a further example of a support structure;

FIG. 2e: schematically represents a perspective view of a further example of a support structure;

FIG. 2f: schematically represents a side view of a further example of a support structure;

FIG. 3a: schematically represents a side view of a further example of a support structure removal strategy using a jetting tool;

FIG. 3b: schematically represents a side view of a further example of a support structure removal strategy using the jetting tool;

FIG. 4: schematically represents a side view of a further example of a support structure removal strategy using a machining tool;

FIG. 5: schematically represents a side view of a further example of a support structure removal strategy using a vibrating tool;

FIG. 6a: schematically represents a bottom view of a further example of a support structure removal strategy using one example of a removal trajectory;

FIG. 6b: schematically represents a bottom view of a further example of a support structure removal strategy using a further example of a removal trajectory; and

FIG. 7: schematically represents a block diagram of a machine learning system.

### DETAILED DESCRIPTION

In the following, a method of producing a three-dimensional object by means of additive manufacturing, a control system for an additive manufacturing device, and an additive manufacturing device for producing a three-dimensional object, will be described. The same or similar reference numerals will be used to denote the same or similar structural features.

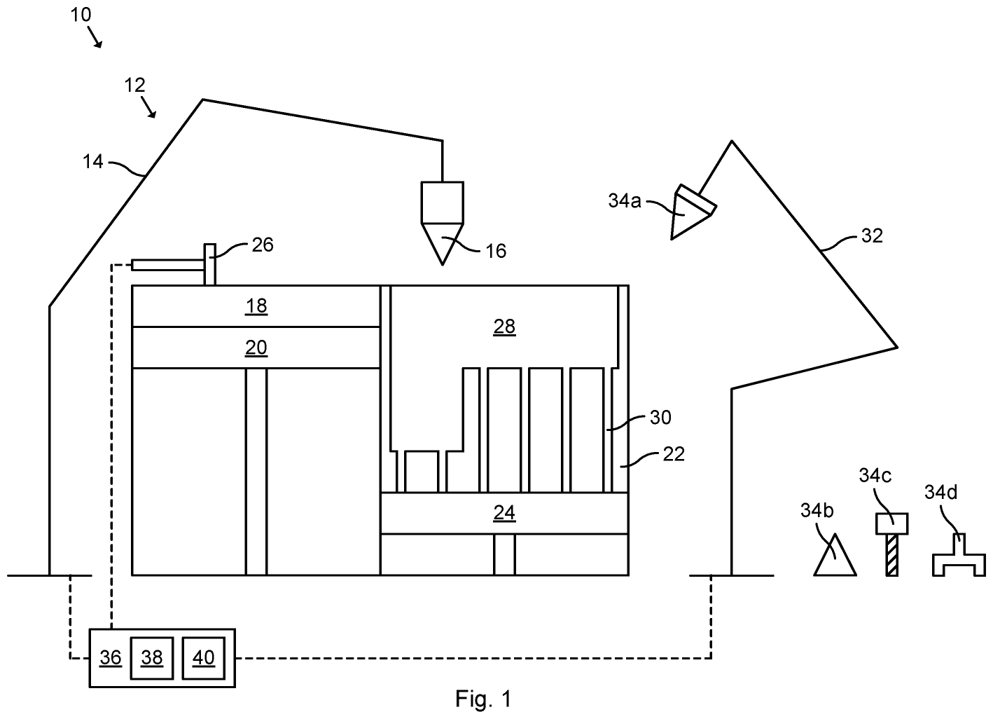

FIG. 1 schematically represents a side view of an additive manufacturing device 10. The additive manufacturing device 10 comprises a printing machine 12. The printing machine 12 of this specific example comprises a printing robot 14 having a printing head 16, such as a laser source, a material reservoir 18, a delivery piston 20 in the material reservoir 18, a production chamber 22, a baseplate 24 in the production chamber 22, and a leveling mechanism 26. By moving the delivery piston 20 upwards and moving the leveling mechanism 26, new material, here exemplified as metal powder, can be introduced to the production chamber 22.

In FIG. 1, a three-dimensional object 28 and support structures 30 for the three-dimensional object 28 are being printed by additive manufacturing in the production chamber 22. The support structures 30 support the three-dimensional object 28 during the printing process and conduct heat away from the three-dimensional object 28. In this example, the support structures 30 are formed as elongated pillars vertically below the three-dimensional object 28.

In order to print the three-dimensional object 28 and the support structures 30, an object model of the three-dimensional object 28 and a support structure model of the support structures 30 are sliced into two-dimensional layers and then turned into a set of instructions for the printing head 16 to execute. The support structures 30 and the three-dimensional object 28 are then formed by adding material one layer at a time. The support structures 30 and the three-dimensional object 28 may for example be produced by means of selective laser sintering (SLS), selective laser melting (SLS), fused deposition modeling (FDM), stereolithography apparatus (SLA) and other material jetting technologies.

The additive manufacturing device 10 of this example further comprises a removal robot 32. In FIG. 1, the removal robot 32 carries a laser tool 34a. By means of the laser tool 34a, the support structures 30 can be removed from the three-dimensional object 28, as described below. As illustrated in FIG. 1, the additive manufacturing device 10 further comprises a jetting tool 34b, a machining tool 34c and a vibrating tool 34d. The removal robot 32 is configured to automatically replace the laser tool 34a with any of the jetting tool 34b, the machining tool 34c and the vibrating tool 34d.

A manual post-processing of the three-dimensional object 28, where the support structures 30 are removed, is labor intensive and not scalable. A most suitable automatic removal strategy however largely depends on the specifics of the three-dimensional object 28 and the support structures 30.

In this example, each of the printing robot 14 and the removal robot 32 comprises a manipulator programmable in three or more axes, such as in six or seven axes. One or both of the printing robot 14 and the removal robot 32 may for example be replaced by a CNC machine.

The additive manufacturing device 10 further comprises a control system 36. The control system 36 comprises a data processing device 38 and a memory 40. The memory 40 has a computer program stored thereon which, when executed by the data processing device 38, causes the data processing device 38 to perform, and/or command performance of, various steps as described herein. As shown in FIG. 1, the control system 36 of this example is in signal communication with the printing robot 14, the removal robot 32 and the leveling mechanism 26.

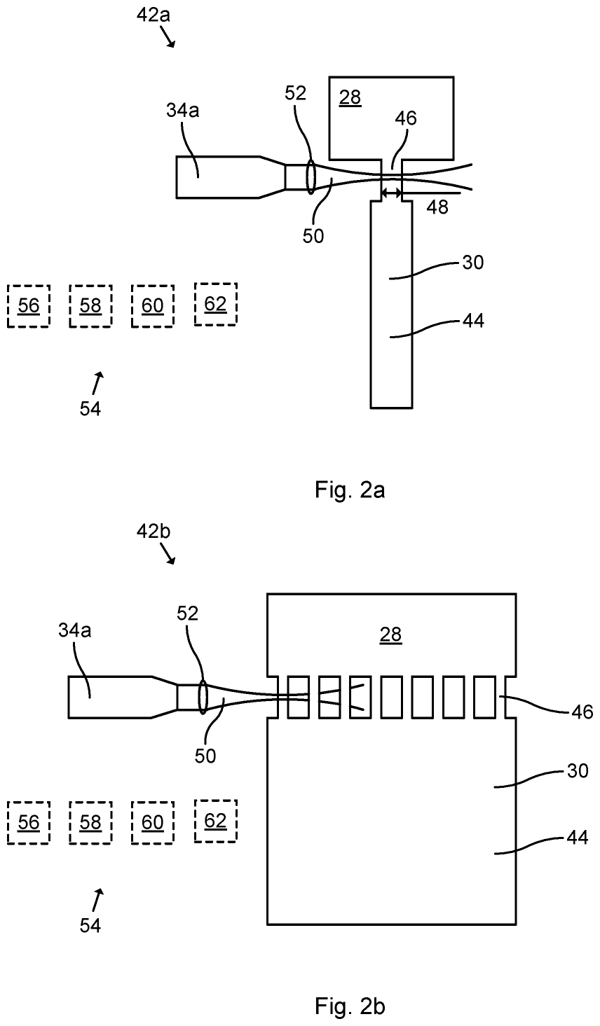

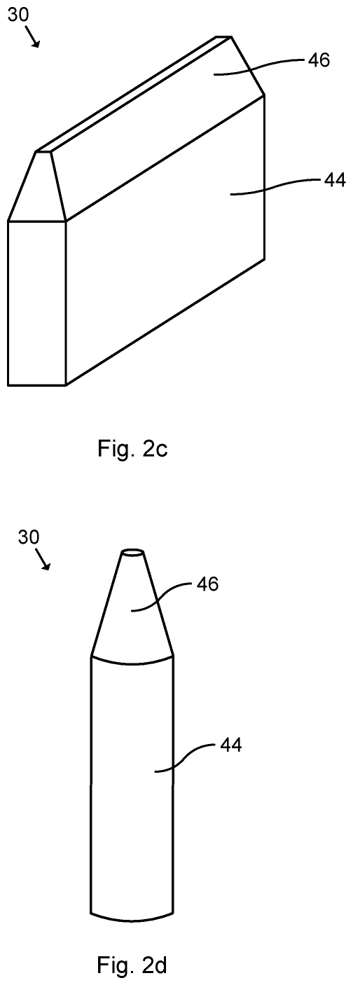

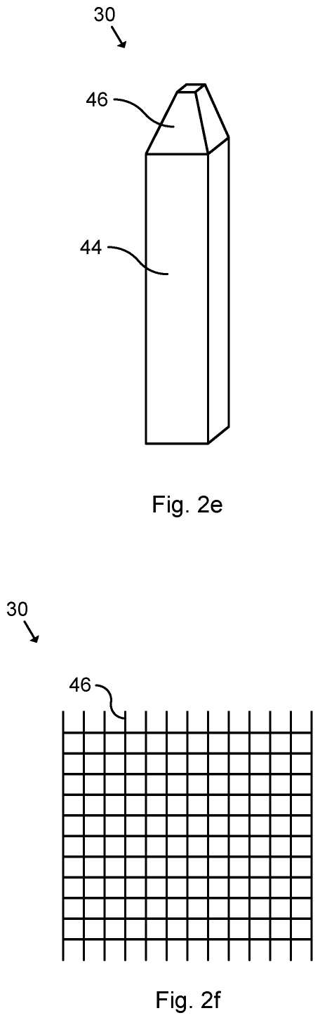

FIG. 2a schematically represents a side view of one example of a support structure removal strategy 42a using the laser tool 34a. FIG. 2a further shows the three-dimensional object 28 and one example of a support structure 30. Although only one support structure 30 is shown, a plurality of such support structures 30 may be provided for the three-dimensional object 28.

The support structure 30 of this example comprises a body 44 and an interconnection 46 between the body 44 and the three-dimensional object 28. The body 44 is wider than the associated interconnection 46. The interconnection 46 has a thickness 48. The body 44 is here exemplified as a cylinder. The interconnection 46 is here exemplified as a cylinder concentric with the body 44 and having a smaller diameter than the body 44. The interconnection 46 thus has a reduced thickness with respect to the body 44. The interconnection 46 is formed to provide an intended breaking point of the support structure 30 from the three-dimensional object 28. The interconnection 46 may have a maximum width of 2 mm or less, such as 1 mm or less.

The removal strategy 42a comprises cutting the interconnection 46 by means of a laser beam 50 from the laser tool 34a irradiated through a lens 52. The interconnection 46 is thereby removed by subtractive removal.

FIG. 2a further schematically illustrates examples of a plurality of process values 54 of process parameters associated with the laser tool 34a when executing the removal strategy 42a. In FIG. 2a, the process parameters include an execution speed 56 of the laser tool 34a, a standoff distance 58 of the laser tool 34a from the support structure 30, a focal length 60, and an intensity 62 of the laser tool 34a.

In the removal strategy 42a, the interconnection 46 is cut by laser vaporization. The laser tool 34a provides a high-energy density laser beam 50 to heat the interconnection 46. The temperature in the interconnection 46 rises rapidly and reaches the boiling point of the metal in a very short period of time. The metal then begins to vaporize and forms vapors. These vapors are ejected at great speed, forming incisions on the metal at the same time as the vapors are ejected. The vaporization heat of the metal is generally very large, so the laser vaporization cutting requires a lot of power and power density. In order to do so in an economic manner, the amount of metal to be removed must be as small as possible and sufficient free (air, gas) volume around the cutting spot must be available.

In the removal strategy 42a, the process parameters of the laser tool 34a are adjusted such that evaporation of metal only occurs within Rayleigh lengths from the waist of the laser beam 50. Removal of the support structure 30 by means of the laser tool 34a constitutes one example of a removal technology according to the present disclosure. After removal of the support structures 30 by the laser tool 34a, the laser tool 34a can be used for surface treatment of the three-dimensional object 28, such as polishing.

FIG. 2b schematically represents a side view of a further example of a support structure removal strategy 42b using the laser tool 34a. Mainly differences with respect to FIG. 2a will be described. In FIG. 2b, the support structure 30 comprises a body 44 and a plurality of interconnections 46 between the body 44 and the three-dimensional object 28. The body 44 of this example is a relatively large and flat cuboid. The interconnections 46 of this example are parallel cylinders. The interconnections 46 form a non-staggered perforation pattern for the laser tool 34a.

FIG. 2c schematically represents a perspective view of a further example of a support structure 30. The support structure 30 of this example comprises an elongated cuboidal body 44 and an elongated tapered interconnection 46 on top of the body 44. The body 44 is horizontally oriented. Also the support structure 30 of this example is thinned and thereby favors laser vaporization cutting.

FIG. 2d schematically represents a perspective view of a further example of a support structure 30. The support structure 30 of this example comprises a cylindrical body 44 and an interconnection 46 in the form of a truncated cone. The interconnection 46 comprises a base with the same diameter as the body 44. The top bridging to the three-dimensional object 28 has a substantially smaller diameter than the base.

FIG. 2e schematically represents a perspective view of a further example of a support structure 30. The support structure 30 of this example comprises a vertically oriented elongated cuboidal body 44 and an interconnection 46 in the form of a truncated square cone on top of the body 44.

FIG. 2f schematically represents a side view of a further example of a support structure 30. The support structure 30 of this example is a grid. The upper portions of the grid lines here constitute the interconnections 46.

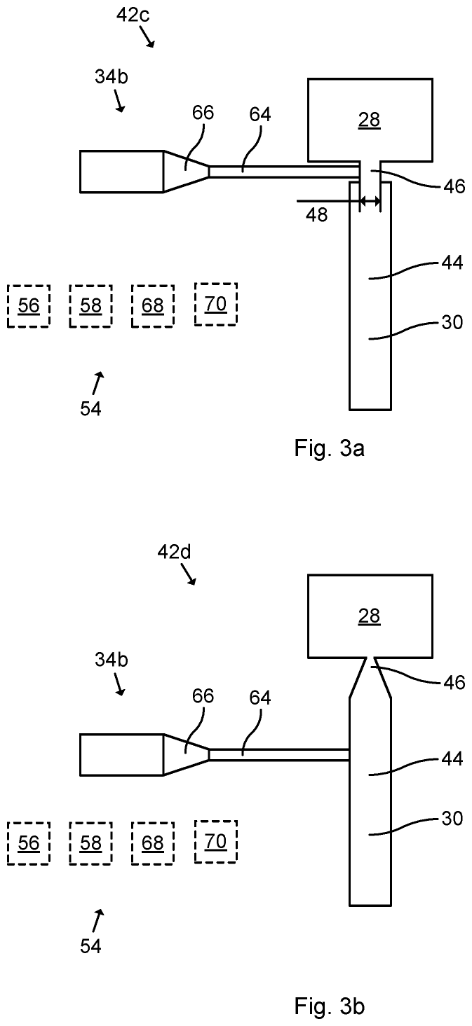

FIG. 3a schematically represents a side view of a further example of a support structure removal strategy 42c using the jetting tool 34b. Mainly differences with respect to FIG. 2a will be described. The jetting tool 34b may for example be an abrasive water injection jetting tool. The removal strategy 42c comprises propelling an abrasive liquid jet 64 containing abrasive particles from a nozzle 66 of the jetting tool 34b to the interconnection 46. The interconnection 46 is thereby cut by the liquid jet 64 to separate the support structure 30 from the three-dimensional object 28.

FIG. 3a further schematically illustrates examples of a plurality of process values 54 of process parameters associated with the jetting tool 34b when executing the removal strategy 42c. In addition to the execution speed 56 of the jetting tool 34b and the standoff distance 58 of the jetting tool 34b from the support structure 30, the process parameters of the removal strategy 42c further include a pressure 68 of the liquid jet 64 and a jet diameter 70.

One advantage associated with the jetting tool 34b is that the standoff distance 58 can be relatively large, such as tens of millimeters, and still achieve a considerable cutting depth. The shape of the support structure 30 and/or the standoff distance 58 can be modified such that the shape of the support structure 30 matches the cutting shape produced by the jetting tool 34b.

Removal of the support structure 30 by cutting the interconnection 46 with the liquid jet 64 from the jetting tool 34b constitutes a further example of a removal technology according to the present disclosure. After removal of the support structures 30 by the jetting tool 34b, the jetting tool 34b can be used for surface treatment of the three-dimensional object 28 by means of the liquid jet 64, such as polishing.

FIG. 3b schematically represents a side view of a further example of a support structure removal strategy 42d using the jetting tool 34b. Mainly differences with respect to FIG. 3a will be described. The support structure 30 of this example comprises an interconnection 46 that tapers towards the three-dimensional object 28.

Instead of cutting the interconnection 46, the removal strategy 42d comprises propelling the liquid jet 64 towards the body 44 to thereby push the body 44 to break the interconnection 46. As shown in FIG. 3b, the body 44 is relatively wide so as to offer a large surface for being hit by the liquid jet 64. The larger surface of the body 44 thus makes it easier for the liquid jet 64 to hit its target. In this way, the positioning accuracy of the liquid jet 64 on the body 44 can be relaxed in comparison with when positioning the liquid jet 64 on the smaller interconnection 46. Moreover, the pressure 68 of the liquid jet 64 can be reduced when pushing away the support structure 30 from the three-dimensional object 28 in comparison with when cutting the interconnection 46. When pushing the support structure 30 in this way, the liquid from the jetting tool 34b does not necessarily have to contain abrasive particles.

Removal of the support structure 30 by pushing by means of the liquid jet 64 from the jetting tool 34b constitutes a further example of a removal technology according to the present disclosure.

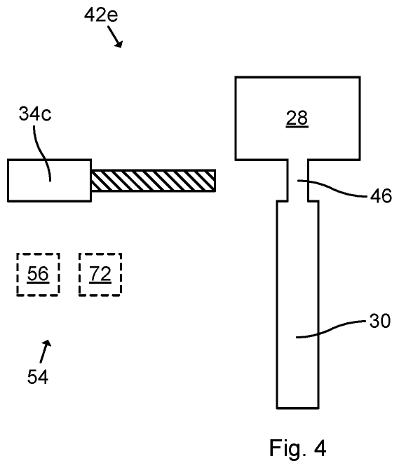

FIG. 4 schematically represents a side view of a further example of a support structure removal strategy 42e using the machining tool 34c. The machining tool 34c is here exemplified as a milling tool. The removal strategy 42e comprises machining of the interconnection 46 to separate the support structure 30 from the three-dimensional object 28.

FIG. 4 further schematically illustrates examples of a plurality of process values 54 of process parameters associated with the machining tool 34c when executing the removal strategy 42e. In addition to the execution speed 56, the process parameters of the removal strategy 42e further include a rotational speed 72 of the machining tool 34c. Removal of the support structure 30 by means of the machining tool 34c constitutes a further example of a removal technology according to the present disclosure.

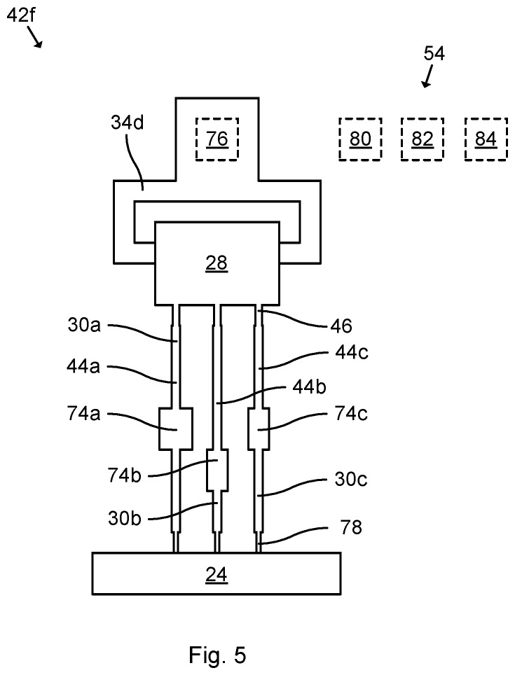

FIG. 5 schematically represents a side view of a further example of a support structure removal strategy 42f using the vibrating tool 34d. The removal strategy 42f constitutes one example of a vibration removal strategy according to the present disclosure.

In this example, the three-dimensional object 28 is provided with three support structures 30a, 30b and 30c. One, several or each of the support structures 30a-30c may alternatively be referred to with reference numeral “30”.

As shown in FIG. 5, the first support structure 30a comprises a first body 44a and a first weight 74a, the second support structure 30b comprises a second body 44b and a second weight 74b, and the third support structure 30c comprises a third body 44c and a third weight 74c. The weights 74a-74c are printed together with the associated bodies 44a-44c of the support structures 30a-30c. One, several or each of the bodies 44a-44c may alternatively be referred to with reference numeral “44”. One, several or each of the weights 74a-74c may alternatively be referred to with reference numeral “74”.

The first weight 74a is larger than the second weight 74b and the third weight 74c. The third weight 74c is positioned closer to the three-dimensional object 28 than the second weight 74b. For this reason, each support structure 30a-30c is provided with a unique eigenfrequency. By vibrating the three-dimensional object 28 with a frequency and direction triggering one of these eigenfrequencies, the associated support structure 30a-30c can be broken from the three-dimensional object 28.

The vibrating tool 34d is here exemplified as a gripper comprising a vibration motor 76. The vibration motor 76 of this example comprises actuators (not illustrated) in three orthogonal axes to allow triggering of eigenfrequencies of the support structures 30a-30c in all possible directions. The actuators may be piezoelectric actuators.

Furthermore, each support structure 30a-30c is connected to the baseplate 24 with a respective baseplate interconnection 78, and connected to the three-dimensional object 28 with a respective interconnection 46. As shown in FIG. 5, the interconnections 46 have a larger thickness than the baseplate interconnections 78. The vibrating tool 34d can thereby brake the respective baseplate interconnection 78 before the interconnections 46 are broken.

FIG. 5 further schematically illustrates examples of a plurality of process values 54 of process parameters associated with the vibrating tool 34d when executing the removal strategy 42f. The process parameters of the removal strategy 42f include a vibration frequency 80, a vibration direction 82 and a vibration amplitude 84.

The removal strategy 42f comprises gripping the three-dimensional object 28 and subjecting the three-dimensional object 28 to vibrations with frequencies 80 triggering the respective eigenfrequencies of the support structures 30a-30c and with relatively low amplitudes 84. In this way, the baseplate interconnections 78 can be broken. The vibrating tool 34d can then lift the three-dimensional object 28 with the support structures 30a-30c connected thereto away from the baseplate 24. The vibrating tool 34d may then subject the three-dimensional object 28 to vibrations with frequencies 80 triggering the respective eigenfrequencies of the support structures 30a-30c and with relatively high amplitudes 84 to break the interconnections 46 from the three-dimensional object 28. One advantage of this is that the three-dimensional object 28 can be lifted out from the production chamber 22 when breaking the support structures 30a-30c from the three-dimensional object 28 by vibrations, for example positioned over a disposal bin.

Removal of the support structure 30 by means of the vibrating tool 34d constitutes a further example of a removal technology according to the present disclosure. In an alternative example, the vibration motor 76 is positioned in the baseplate 24. One, several or each of the tools 34a-34d may alternatively be referred to with reference numeral “34”.

With each of the removal strategies 42a-42f, the support structures 30 are removed from the three-dimensional object 28 with great accuracy, leading to an improved surface quality of the three-dimensional object 28 at the positions of the interconnections 46. The automatic removal of the support structures 30 also greatly reduce costs associated with the additive manufacturing.

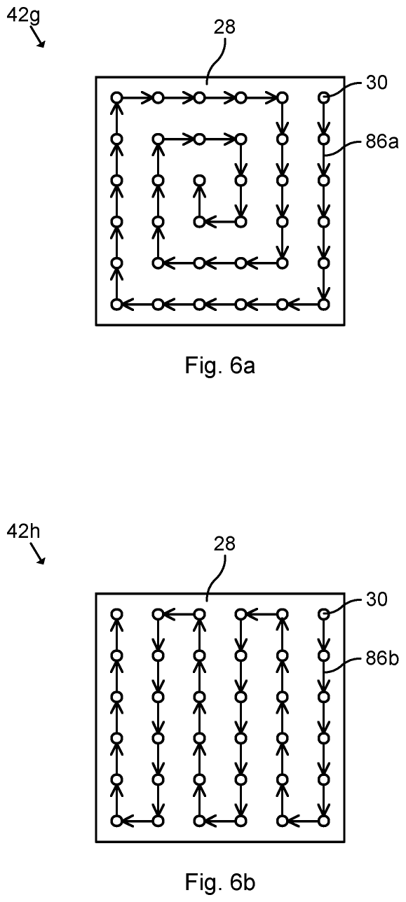

FIG. 6a schematically represents a bottom view of a further example of a support structure removal strategy 42g using one example of a removal trajectory 86a. The removal trajectory 86a can be used with each of the removal technologies of the removal strategies 42a-42f. In FIG. 6a, the support structures 30 are positioned in a matrix. The removal trajectory 86a comprises a sequential removal of the support structures 30 generally along a spiral-shaped path. When executing the removal strategy 42g, the path of the removal trajectory 86a is followed by the removal robot 32.

FIG. 6b schematically represents a bottom view of a further example of a support structure removal strategy 42h using a further example of a removal trajectory 86b. The removal trajectory 86b can be used for each of the removal strategies 42a-42f. The removal trajectory 86b comprises a sequential removal of the support structures 30 generally along a zig zag-shaped path.

One or both of the removal trajectories 86a and 86b may alternatively be referred to with reference numeral “86”. By modifying the removal trajectory 86, the access to the interconnections 46 can be improved. One, several or all of the removal strategies 42a-42h may alternatively be referred to with reference numeral “42”.

As detailed above, a wide range of designs of support structures 30 and a wide range of removal strategies 42 are available. It is therefore very challenging to manually find a most appropriate support structure 30 and the most appropriate removal strategy 42. A manually customized removal strategy 42 may work well for one implementation, but not at all for another implementation. Manually customized removal strategies 42 are therefore unwieldy and expensive due to the large amount of different designs. Moreover, executing a customized removal strategy 42 generated by experts does not guarantee the quality of the three-dimensional object 28.

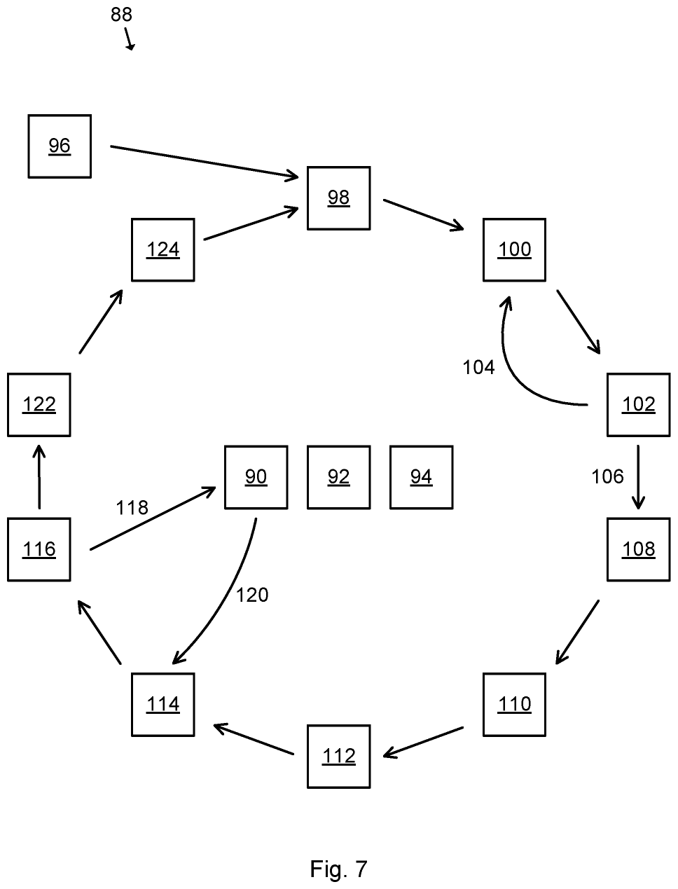

FIG. 7 schematically represents a block diagram of one example of a machine learning system 88 and various steps in a method of producing a three-dimensional object 28. The machine learning system 88 may for example be implemented in the control system 36. The machine learning system 88 of this specific example comprises a digital twin 90, a machine learning agent 92 and a database 94.

The digital twin 90 is a virtual model representing the additive manufacturing device 10, or one or more sections thereof. In particular, the digital twin 90 can simulate the interaction of the removal robot 32 with the three-dimensional object 28 and the support structures 30. The digital twin 90 may also model the tools 34, the three-dimensional object 28, vision systems, vises, clamps, etc.

The digital twin 90 comprises a plurality of virtual components corresponding to a plurality of mechanical components and/or electrical components of the additive manufacturing device 10. The digital twin 90 takes into account the effect of the respective virtual component and its interaction with other virtual components. The digital twin 90 mimics the geometry and dynamic behavior of the environment encountered when removing the support structures 30. The digital twin 90 can perform various simulations, for example of different removal strategies 42, and provide one or more virtual output parameters from such simulations. The virtual output parameters may for example correspond to the process values 54. The virtual output parameters may correspond to process values 54 as measured by sensors on the additive manufacturing device 10, and/or may correspond to process values 54 that are not measured by sensors on the additive manufacturing device 10.

The database 94 stores virtual output parameters from the digital twin 90 and process values 54 from the additive manufacturing device 10. In this way, experience regarding the behavior of the additive manufacturing device 10 can be gathered. The database 94 may for example contain information regarding optimal profiles of the support structures 30 for different types of printing material and/or abrasive parametrizations for the jetting tool 34b. The database 94 records past successful process values 54 in order to reuse them when similar demands arise and/or to synthesize new process values 54 that can be used to initialize the machine learning agent 92.

The machine learning agent 92 employs algorithms to automatically build and improve a mathematical model through experience and using sample data. The machine learning agent 92 is trained by the sample data. The sample data may for example comprise the virtual output parameters from the digital twin 90 and/or information from the database 94. The machine learning agent 92 is configured to learn and predict the best removal technology, the best design of support structures 30, the best process values 54 and the best removal trajectory 86 for different designs of the three-dimensional object 28 and the associated support structures 30.

The machine learning agent 92 and the digital twin 90 operate in lockstep, improving the removal process until it satisfies some prespecified performance criteria, such as accuracy, execution speed 56, computation time or surface roughness. The machine learning agent 92 is configured to supply input data to the digital twin 90. Examples of input data include removal trajectories 86, process values 54, object models of three-dimensional object 28, and candidate support structure models of the support structures 30. The digital twin 90 is configured to react dynamically to input data from the machine learning agent 92.

The digital twin 90 can be queried with different levels of accuracy. For example, the digital twin 90 may simulate the interaction of a tip of the machining tool 34c with higher accuracy than a vision system, which can simply rely on geometric data of the three-dimensional object 28 and the support structures 30 independent of the material. The digital twin 90 can provide information regarding the execution of a specific removal strategy 42 and its process values 54. The digital twin 90 may for example receive a binary query of whether or not the machining tool 34c collides with the three-dimensional object 28 or the support structures 30. The corresponding binary output parameter from the digital twin 90 can be used by the machine learning agent 92 as a reward (if the machining tool 34c is not colliding) or a penalty (if the machining tool 34c is colliding). Further examples of queries from the machine learning agent 92 to the digital twin 90 are the time spent to execute the full removal strategy 42 and the accuracy with which the support structures 30 are removed. Corresponding response outputs from the digital twin 90 can be used in a reward/penalty function of the machine learning agent 92.

The method comprises a step 96 of providing an object model of the three-dimensional object 28. Also the object model may be referred to with reference numeral “96”. The object model 96 may be a CAD model of the three-dimensional object 28 and may contain information regarding a material thereof.

The method further comprises a step 98 of providing a candidate support structure model. Also the candidate support structure model may be referred to with reference numeral “98”. The candidate support structure model 98 is a model of the support structures 30 for supporting the three-dimensional object 28. The candidate support structure model 98 is provided based on the object model 96. For example, more support structures 30 are typically needed for larger three-dimensional objects 28. The candidate support structure model 98 may be provided by the machine learning agent 92. Also the candidate support structure model 98 may be a CAD model of the support structures 30 and may contain information regarding a material thereof. Step 98 may further comprise a determination of an optimal orientation of the three-dimensional object 28 during the additive manufacturing.

The method further comprises a step 100 of selecting a removal strategy 42 among a plurality of candidate removal strategies 42, such as the removal strategies 42a-42h. The selection of the removal strategy 42 is here made based on the object model 96 and the candidate support structure model 98. In this example, the selection of the removal strategy 42 is made by the machine learning agent 92. The selection of the removal strategy 42 may comprise first selecting a type of removal technology and a subsequent generation of a removal trajectory 86 and/or process values 54 for the selected removal technology.

For a particular object model 96 of the three-dimensional object 28, one removal technology may be more suitable than another removal technology. This may for example have to do with accessibility due the size of the tool 34, strength of material of the three-dimensional object 28, structural rigidity of the three-dimensional object 28, if the material can be wetted etc. Furthermore, one removal trajectory 86 may for example be more suitable than another removal trajectory 86 depending on a center of gravity of the three-dimensional object 28 as determined based on the object model 96. As further examples, a required intensity 62 of the laser tool 34a, a required pressure 68 of the jetting tool 34b, a required rotational speed 72 of the machining tool 34c or a required frequency 80 of the vibrating tool 34d can be considered in view of the object model 96 of the three-dimensional object 28.

The method further comprises a step 102 of estimating one or more process values 54 of process parameters associated with the selected removal strategy 42 for the candidate support structure model 98. If process values 54 have already been generated in step 100, step 102 may comprise estimating additional process values 54. In any case, the digital twin 90 may be used for such estimations. The estimations may comprise executing the selected removal strategy 42 in the digital twin 90 and collect rewards/penalties from the digital twin 90.

The method of this example further comprises a step 104 of modifying the selected removal strategy 42 based on the estimations in step 102. The modification may be made by means of the machine learning agent 92 or by an optimization algorithm.

The modified removal strategy 42 is then provided as offline feedback to step 100. Steps 100 and 102 can then be repeated using the modified removal strategy 42. Also step 104 can be repeated. Thus, based on an initially selected removal strategy 42 comprising a particular removal trajectory 86 and process values 54 (both of which may be chosen conservatively, or may be pre-programmed, or may be obtained by any other heuristic), the selected removal strategy 42 can be incrementally improved.

The method further comprises a step 106 of modifying the candidate support structure model 98 based on the selected removal strategy 42 to provide a modified support structure model 108. This modification may be performed by the machine learning agent 92. Alternatively, or in addition, this modification may comprise an optimization of the candidate support structure model 98, e.g. to satisfy an objective function associated with the process values 54, to provide an optimized support structure model which can then be used as the modified support structure model 108.

The modified support structure model 108 may for example differ from the candidate support structure model 98 with the number of support structures 30, the positioning of the support structures 30 relative to the three-dimensional object 28, and/or the designs of the support structures 30, such as the interconnections 46. The modification of the candidate support structure model 98 to provide the modified support structure model 108 may be made by the machine learning agent 92 based on collected rewards/penalties from the digital twin 90.

The method further comprises a step 110 of adjusting the selected removal strategy 42 based on the modified support structure model 108. Also this modification of the selected removal strategy 42 may be made by the machine learning agent 92 based on collected rewards/penalties from the digital twin 90. When the machine learning agent 92 performs adequately for the modified support structure model 108 and the selected removal strategy 42 given one or more predetermined criteria (e.g. from the user), the process is deployed to the additive manufacturing device 10.

The method further comprises a step 112 of additive manufacturing. In step 112, the support structures 30 are formed based on the modified support structure model 108 and the three-dimensional object 28 is formed based on the object model 96.

The method further comprises a step 114 of removing the support structures 30 from the three-dimensional object 28 based on the selected removal strategy 42, optionally as adjusted in step 110. The removal strategy 42 is thus deployed to the real world environment, here to the removal robot 32.

The method further comprises a step 116 of online inspection of the support structures 30 and/or the three-dimensional object 28 during the removal of the support structures 30 in step 114. The online inspection in step 116 may comprise sensory feedback from the additive manufacturing device 10. The sensory feedback may be sent to the digital twin 90 as shown with arrow 118. The digital twin 90 provides this feedback to the machine learning agent 92. Online feedback is then provided to the removal process in step 114 as shown with arrow 120. Thus, during removal of the support structures 30, the machine learning agent 92 can passively learn from the actual performance of the removal robot 32 and can adjust the removal strategy 42 in real time.

The method further comprises a step 122 of final inspection. The method further comprises a step 124 of updating the database 94. For example, the sensory feedback from the additive manufacturing device 10 during the removal step 114 may be sent to the database 94 and stored therein.

The removal strategy 42 may proceed in batches of printed three-dimensional objects 28. In a first batch, the removal strategy 42 is executed and sensory feedback is used to improve the digital twin 90. In this way, discrepancies between the expected behavior of the removal robot 32 and the digital twin 90 are reduced by changing models employed by the digital twin 90.

In a second batch of printed three-dimensional objects 28, the removal strategy 42 is executed and the reward/penalty function of the machine learning agent 92 is used to improve the removal strategy 42. The machine learning agent 92 continues to improve the digital twin 90 and the removal strategy 42 until the removal strategy 42 is satisfactory, given some predefined criteria. The digital twin 90 is thus continuously or regularly updated and/or retuned to better match the behavior of the removal robot 32. Batches of printed three-dimensional objects 28 that have been used for training purposes can be reprocessed when the removal robot 32 has reached a satisfactory performance level if the training processing steps have not damaged the three-dimensional objects 28. By means of the machine learning system 88, the removal of support structures 30 can be automated and improved without requiring experts to tune the parametrization of the additive manufacturing device 10.

The database 94 contains all historical information, for example regarding process parameters for different design options. When the same or similar design option arises, the same process values 54 are utilized for the initialization of the machine learning agent 92. When a different design option arises, the database 94 extrapolates on the most probable process values 54 and uses this parametrization for the initialization of the machine learning agent 92. The database 94 can be updated using computational resources offline in order to more effectively utilize the control system 36.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of producing a three-dimensional object, the method comprising:
providing an object model of the three-dimensional object;
providing a candidate support structure model of one or more support structures for the three-dimensional object based on the object model;
selecting a removal strategy among a plurality of candidate removal strategies for removal of the one or more support structures from the three-dimensional object based on the object model;
modifying the candidate support structure model based on the selected removal strategy to provide a modified support structure model;
forming the three-dimensional object based on the object model, and the one or more support structures supporting the three-dimensional object based on the modified support structure model, by means of additive manufacturing; and
removing the one or more support structures from the three-dimensional object based on the selected removal strategy.

2. The method according to claim 1, further comprising:
estimating one or more process values associated with the selected removal strategy for the candidate support structure model; and
modifying the candidate support structure model based on the one or more process values to provide the modified support structure model.

3. The method according to claim 2, further comprising:
performing optimization of the candidate support structure model to satisfy an objective function associated with the one or more process values to output an optimized support structure model; and
using the optimized support structure model as the modified support structure model.

4. The method according to claim 1, wherein the selection of the removal strategy and/or the modification of the candidate support structure model is made by means of machine learning.

5. The method according to claim 1, wherein the forming of the three-dimensional object and the removal of the one or more support structures are performed by means of an additive manufacturing device, and wherein the method further comprises:
providing a digital twin of the additive manufacturing device; and
selecting the removal strategy and/or modifying the candidate support structure model by using the digital twin.

6. The method according to claim 1, wherein the candidate removal strategies are associated with different removal trajectories.

7. The method according to claim 1, wherein the candidate removal strategies are associated with different tools.

8. The method according to claim 7, wherein the tools comprise a laser tool, a jetting tool, a machining tool and/or a vibrating tool.

9. The method according to claim 1, wherein the candidate removal strategies include one or more vibration removal strategies including introducing vibrations to one or more of the support structures to excite an eigenfrequency of the one or more support structures such that one or more interconnections between the three-dimensional object and each of the one or more support structures brake.

10. A control system for an additive manufacturing device, the control system comprising at least one data processing device and at least one memory having at least one computer program stored thereon, the at least one computer program including a program code which, when executed by the at least one data processing device, causes the at least one data processing device to perform the steps of:
providing an object model of a three-dimensional object;
providing a candidate support structure model of one or more support structures for the three-dimensional object based on the object model;
providing a selection of a removal strategy among a plurality of candidate removal strategies for removal of the one or more support structures from the three-dimensional object based on the object model;
modifying the candidate support structure model based on the selected removal strategy to provide a modified support structure model;
commanding forming of the three-dimensional object based on the object model, and the one or more support structures supporting the three-dimensional object based on the modified support structure model, by means of additive manufacturing; and
commanding removal of the one or more support structures from the three-dimensional object based on the selected removal strategy.

11. The control system according to claim 10, wherein the at least one computer program comprises program code which, when executed by the at least one data processing device, causes the at least one data processing device to perform the steps of:
estimating one or more process values associated with the selected removal strategy for the candidate support structure model; and
modifying the candidate support structure model based on the one or more process values to provide the modified support structure model.

12. The control system according to claim 11, wherein the at least one computer program comprises program code which, when executed by the at least one data processing device, causes the at least one data processing device to perform the steps of:
performing optimization of the candidate support structure model to satisfy an objective function associated with the one or more process values to output an optimized support structure model; and
using the optimized support structure model as the modified support structure model.

13. The control system according to claim 10, wherein the selection of the removal strategy and/or the modification of the candidate support structure model is made by means of machine learning.

14. The control system according to claim 10, wherein the forming of the three-dimensional object and the removal of the one or more support structures are performed by means of an additive manufacturing device, and wherein the at least one computer program includes a program code which, when executed by the at least one data processing device, causes the at least one data processing device to perform the steps of:
providing a digital twin of the additive manufacturing device; and
selecting the removal strategy and/or modifying the candidate support structure model by using the digital twin.

15. An additive manufacturing device for producing a three-dimensional object, the additive manufacturing device comprising a control system including at least one data processing device and at least one memory having at least one computer program stored thereon, the at least one computer program including a program code which, when executed by the at least one data processing device, causes the at least one data processing device to perform the steps of:
providing an object model of a three-dimensional object;
providing a candidate support structure model of one or more support structures for the three-dimensional object based on the object model;
providing a selection of a removal strategy among a plurality of candidate removal strategies for removal of the one or more support structures from the three-dimensional object based on the object model;
modifying the candidate support structure model based on the selected removal strategy to provide a modified support structure model;
commanding forming of the three-dimensional object based on the object model, and the one or more support structures supporting the three-dimensional object based on the modified support structure model, by means of additive manufacturing; and
commanding removal of the one or more support structures from the three-dimensional object based on the selected removal strategy.

16. The method according to claim 2, wherein the selection of the removal strategy and/or the modification of the candidate support structure model is made by means of machine learning.

17. The method according to claim 2, wherein the forming of the three-dimensional object and the removal of the one or more support structures are performed by means of an additive manufacturing device, and wherein the method further comprises:
providing a digital twin of the additive manufacturing device; and
selecting the removal strategy and/or modifying the candidate support structure model by using the digital twin.

18. The method according to claim 2, wherein the candidate removal strategies are associated with different removal trajectories.

19. The method according to claim 2, wherein the candidate removal strategies are associated with different tools.

20. The method according to claim 2, wherein the candidate removal strategies include one or more vibration removal strategies including introducing vibrations to one or more of the support structures to excite an eigenfrequency of the one or more support structures such that one or more interconnections between the three-dimensional object and each of the one or more support structures brake.
